(19) United States
(12) Patent Application Publication
(10) Pub. No.: US 2025/0307515 A1
(43) Pub. Date: Oct. 2, 2025

(54) Method for Implementing Timing Closure of Ultra-Large-Scale SOC Based on Module Division

(71) Applicant: Jiangsu Huachuang Microsystem Company Limited, Nanjing (CN)

(72) Inventors: Zhenkun SONG, Nanjing (CN); Guoqiang HE, Nanjing (CN); Shiping LI, Nanjing (CN); Bing HU, Nanjing (CN); Haibin ZHOU, Nanjing (CN)

(73) Assignee: Jiangsu Huachuang Microsystem Company Limited, Nanjing (CN)

(21) Appl. No.: 19/004,525

(22) Filed: Dec. 30, 2024

(30) Foreign Application Priority Data
Mar. 27, 2024 (CN) 202410359673.X

(51) Int. Cl. G06F 30/392; G06F 30/3312; G06F 30/394

(52) U.S. Cl. CPC G06F 30/392; G06F 30/3312; G06F 30/394

(57) ABSTRACT

A method for implementing timing closure of an ultra-large-scale SOC based on module division includes the following steps: S1, acquiring timing data of a full chipset, and dividing an SOC into three modules; S2, reading lib, lef, netlist and def in each module, determining each specific module requiring timing recovery and each prototype module not requiring timing recovery, reading lib and lef in each specific module, and reading netlist and def in each prototype module; S3, creating multiple process corners and acquiring timing data of each process corner, and back-annotating and reading netlist and def out of the multiple process corners corresponding to each specific module to determine an attribute-maintained part and a to-be-recovered part; and setting the attribute-maintained part and each prototype module to be in a not-to-be-recovered state; and S4, sending out a timing recovery command, and performing timing violation fixing on the to-be-recovered part.

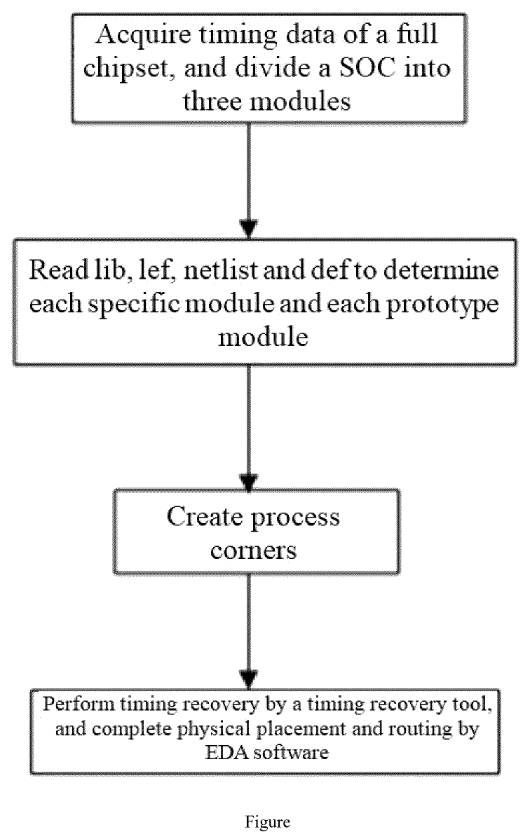

### CROSS REFERENCE TO THE RELATED APPLICATIONS

This application is based upon and claims priority to Chinese Patent Application No. 202410359673.X, filed on Mar. 27, 2024, the entire contents of which are incorporated herein by reference.

### TECHNICAL FIELD

The invention relates to the field of timing closure of ultra-large-scale System on Chips (SOCs), in particular to a method for implementing timing closure of an ultra-large-scale SOC based on module division.

### BACKGROUND

Timing closure of SOCs is mainly involved in the fields related to integrated circuit design and timing analysis. Within the continuous improvement of the complexity and integrity of chip design, timing closure becomes crucial in the design process. Timing closure is implemented to ensure that a system circuit can perform specific functions according to a set sequence to satisfy designed timing requirements, and this involves accurate control of the processing speed and wiring delay of different cell circuits in a system. In SOC design, timing closure not only concerns the performance and stability of chips, but also has a direct influence on the final quality and market competitiveness of products.

To implement timing closure to realize timing recovery of a whole SOC, a series of advanced techniques and approaches need to be adopted, and designers need to have a deep understanding of the timing properties of a system, including timing relations between modules and cell circuits; and then, timing violations are balanced and handled by optimizing the circuit structure, controlling the clock frequency and adding buffers.

With the development of advanced processes, the scale of SOCs is becoming increasingly larger, and ultra-large-scale SOCs have been developed, leading to more process corners in timing closure. However, existing method for implementing timing closure of ultra-large-scale SOCs have at least the following two problems:
(I) In the timing closure process, because the size of data to be accessed for timing recovery becomes ever larger, specific high-performance servers are often used to process data, and common servers can no longer satisfy the requirements of timing tools for the storage performance of servers; the servers are input costs for chip development, and higher-configuration servers are generally more expensive, and the use of more high-performance servers will lead to a higher cost of chips;
(II) Timing recovery tools are inapplicable to overall timing recovery of ultra-large-scale SOCs and will become unstable if the size of data is too large during timing recovery, the timing recovery time is too long, and the timing recovery process is slow.

### SUMMARY

In view of the problems (I) and (II), the invention aims to optimize the timing closure process of ultra-large-scale SOCs to reduce costs, improve efficiency and shorten the timing recovery time under the condition of guaranteeing the timing recovery effect.

To settle the above technical issue, the invention provides a method for implementing timing closure of an ultra-large-scale SOC based on module division; which is implemented by the following technical solution:

A method for implementing timing closure of an ultra-large-scale SOC based on module division, using a timing recovery tool and Electronic Design Automation (EDA) software to perform timing closure of an ultra-large-scale SOC, wherein the method includes the following steps:
S1, acquiring timing data of a full chipset in the ultra-large-scale SOC, and dividing the ultra-large-scale SOC into three modules;
S2, reading each corresponding lib file, lef file, netlist and def file in each module, and determining each specific module requiring timing recovery and each prototype module not requiring timing recovery;
S3, creating, in the timing recovery tool, multiple corresponding process corners for each specific module determined in S2, and acquiring timing data corresponding to each process corner; back-annotating and reading, by the timing recovery tool, each corresponding netlist and def file out of the multiple process corners corresponding to each specific module to determine an attribute-maintained part and a to-be-recovered part; setting the attribute-maintained part and each prototype module determined in S2 to be in a not-to-be-recovered state; and
S4, sending out, by the timing recovery tool in S3, a timing recovery command to perform timing violation fixing on the to-be-recovered part determined in S3; after the timing violation fixing is completed, sending, by the timing recovery tool, script data corresponding to the timing violation fixing to the EDA software; performing physical placement and routing by the EDA software according to the script data to complete one epoch of timing closure.

A large amount of timing data of an ultra-large-scale SOC is divided into groups by module division, such that the processing pressure in timing recovery is effectively reduced, a high-performance server is not needed, and the cost is effectively reduced; moreover, by back-annotating netlist and def to quicky determine parts requiring timing recovery and parts not requiring timing recovery, the timing recovery speed can be increased; in addition, a timing recovery tool and EDA software are used for timing recovery, such that the accuracy of timing recovery is guaranteed.

Preferably, the ultra-large-scale SOC includes a top only layer, a processor, an artificial intelligence processor, a memory and an interface module; and in S1, the ultra-large-scale SOC is divided into a module 1, a module 2 and a module 3; wherein, the module 1 includes the top only layer and the processor, the module 2 includes the top only layer and the artificial intelligence processor, and the module 3 includes the top only layer, the memory and the interface module. By dividing the ultra-large-scale SOC into three modules, the data processing pressure can be effectively reduced, and the situation that data cannot be processed by the timing recovery tool because the size of the data is too large is avoided; a top only layer is shared by all modules, such that connection and interaction between different modules can be realized, and the cost is reduced by sharing various resources in the top only layer.

Preferably, in S2, when each specific module requiring timing recovery is determined, if there are at least two specific modules, the at least two specific modules are processed parallelly. In a case where there are at least two modules requiring timing recovery, the at least two modules are processed parallelly, such that the processing speed can be effectively increased, and the timing recovery and closure time is shortened.

Preferably, in S3, the multiple process corners are created according to a process parameter, a voltage parameter and a temperature parameter corresponding to each specific module. The process parameter, voltage parameter and temperature parameter are important factors that affect the performance of the ultra-large-scale SOC, so process corners are set for these important factors to facilitate data control and subsequent timing recovery.

Preferably, in S4, a method for performing the timing violation fixing includes: analyzing a timing margin on a data path of the to-be-recovered part, selecting nodes with the timing margin from the data path, and changing placement and routing of the nodes to perform timing recovery. Nodes with timing margins are selected for timing recovery, such that positions to be recovered can be determined quickly, and the accuracy of timing recovery is guaranteed.

Preferably, the method further including: setting iteration epochs, and after the epoch of timing closure in S4 is completed, repeating S1-S4 according to the iteration epochs. By means of multiple epochs of iterations, timing closure can be completed effectively, and the timing closure effect is improved.

Preferably, the method further including: after the physical placement and routing in S4 are completed, performing timing verification on the script data in the EDA software. EDA software is used for timing verification, such that the accuracy of timing recovery can be guaranteed, and an error can be detected in time.

Preferably, in a case where an error is detected in the timing verification, a position corresponding to the error is determined according to the script data, and the timing violation fixing in S4 is performed again on the position corresponding to the error. When an error is detected, the position corresponding to the error can be recovered, the position corresponding to the error can be targeted to be recovered, such that the waste of resources and time caused by timing recovery of the whole SOC is avoided.

Compared with the prior art, the invention has the following beneficial effects:

According to the technical solution of the invention, a large amount of timing data of the ultra-large-scale SOC is divided into groups by module division, such that the processing pressure in timing recovery is effectively reduced, a high-performance server is not needed, and the cost is effectively reduced; moreover, by back-annotating netlist and def to quicky determine parts requiring timing recovery and parts not requiring timing recovery, the timing recovery speed can be increased; in addition, multiple epochs of iterations can be performed to realize efficient timing closure.

### BRIEF DESCRIPTION OF THE DRAWINGS

FIGURE is a flow diagram of a method for implementing timing closure of an ultra-large-scale SOC based on module division.

### DETAILED DESCRIPTION OF THE EMBODIMENTS

The technical solutions in some embodiments of the invention are described in detail below in conjunction with drawings of these embodiments.

### EMBODIMENT

As shown in FIGURE which is a flow diagram of a method for implementing timing closure of an ultra-large-scale SOC based on module division, after a full chipset is divided into three modules, a specific module requiring timing recovery is determined quickly, and then timing recovery is performed by means of process corners and a timing recovery tool, such that timing closure is implemented successfully.

A method for implementing timing closure of an ultra-large-scale SOC based on module division uses a timing recovery tool and EDA software to perform timing closure of an ultra-large-scale SOC. The method specifically includes the following steps:
S1, timing data of a full chipset in the ultra-large-scale SOC are obtained by means of the timing recovery tool, and the ultra-large-scale SOC is divided into three modules. Here, a common server rather than a high-performance server is used.

In this embodiment, the ultra-large-scale SOC includes a top only layer, a processor, an artificial intelligent processor, a memory and an interface module; in S1, the ultra-large-scale SOC is divided into a module 1, a module 2 and a module 3; wherein, the module 1 includes the top only layer and the processor; the module 2 includes the top only layer and the artificial intelligent processor; and the module 3 includes the top only layer, the memory and the interface module. By dividing the ultra-large-scale SOC into three modules, the data processing pressure can be effectively reduced, and the situation that data cannot be processed by the timing recovery tool because the size of the data is too large is avoided. The three modules share the top only layer, such that the design consistency is guaranteed, the overall process and subsequent verification can be simplified, and connection and interaction between different modules can be realized; in addition, the top only layer includes some sharable resources and functions such as a bus interface and a clock distribution network, and by sharing these resources and functions, the use of extra resources can be reduced, thus reducing costs and improving efficiency.
S2, each corresponding lib file, lef file, netlist and def file in each module are read, and each specific module requiring timing recovery and each prototype module not requiring timing recovery are determined. Each corresponding lib file and lef file in each specific module are read, and each corresponding netlist and def file in each prototype module are read.

In this embodiment, in S2, when each specific module requiring timing recovery is determined, if there are at least two specific modules, the at least two specific modules are processed parallelly. In a case where there are at least two modules requiring timing recovery, the at least two modules are processed parallelly, such that the processing speed can be effectively increased, and the timing recovery and closure time is shortened.
S3, multiple process corners are created in the timing recovery tool for each specific module determined in S2, and timing data corresponding to each process corner is acquired; and each corresponding netlist and def file are back-annotated and read out of the multiple process corners corresponding to each specific module by means of the timing recovery tool to determine an attribute-maintained part and a to-be-recovered part; and the attribute-maintained part and each prototype module determined in S2 are set to be in not-to-be-recovered state.

It should be noted that each module in the ultra-large-scale SOC is formed by standard cells defined by a process library, and macro cells, and these cells are the most basic units during timing recovery. The lib file includes detailed timing information of each cell, such as delay and power, and this information is indispensable for the timing recovery tool because the timing recovery tool needs to acquire the delay characteristics of each cell to accurately simulate and optimize the timing performance of a circuit in the recovery process. The Lef file provides geometrical shapes and connection relations of these cells, and with reference to this information, the timing recovery tool can know the placement and routing condition of the cells to more accurately analyze timing problems. The netlist describes the connection relations between the cells in circuit design, and by reading the netlist, the timing recovery tool can recognize the modules and the cells in the modules to analyze signal transmission paths and timing relations between the modules and the cells in the modules. The def file provides physical placement information in design, including the specific position of each cell on the ultra-large-scale SOC, the direction of each cell, and the connection relations between the cells, and by reading the def file, the timing recovery tool can accurately determine the position of each cell in the physical placement to realize more accurate timing calculation and analysis. With reference to this information, the timing recovery tool can realize back-annotation of timing information, that is, the timing recovery tool can map the timing data to corresponding units and connection relations according to the actual circuit placement and cell characteristics. In this way, the timing recovery tool can detect and solve timing problems, such as delay mismatching and timing violations, based on the information, thus improving the timing performance of a whole circuit.

In this embodiment, the process corners are created in S3 according to the corresponding process parameter, voltage parameter and temperature parameter of each specific module. Timing delays of timing paths under different process corners are different because actual cell delays and wire delays are different. A method for creating the multiple process corners may include the following steps: (1) each key parameter of each specific module is determined, wherein the key parameters at least include the process parameter, the voltage parameter and the temperature parameter; the range of each process corner is set; (2) modeling, simulation and verification are performed according to each key parameter and each process corner; and (3) after the verification succeeds, multiple process corners are created.

It should be noted that the process corners are different combinations of process parameters and used for depict possible variations and uncertainties in the fabrication process. These process parameters may include the length and width of each module or cell, the thickness of an oxide layer, and the doping concentration. A tiny change of these parameters may exert an influence on the performance of chips. Therefore, the process corner, as a method for taking into account process variations in design and verification, can be introduced to reflect uncertainties and variations in the fabrication to ensure that the design can function normally in various conditions. By defining different process corners, a design team can make corresponding optimizations and adjustments.
S4, a timing recovery command is sent out by the timing recovery tool in S3, wherein the timing recovery tool may be a PRIME_TIME tool; timing violation fixing is performed on the to-be-recovered part in S3, wherein timing violations include setup violations, hold violations and the like, these violations possibly happen to the interface module, the processor and the artificial intelligence processor, and the sum of violation values of all the violations is a full-chip violation value; after the timing violation fixing is completed, script data corresponding to the timing violation fixing are sent to the EDA software by the timing recovery tool; and the EDA software performs actual physical placement and routing according to the script data to complete one epoch of time closure.

In this embodiment, in S4, a method for performing timing violation fixing includes: a timing margin on a data path of the to-be-recovered part is analyzed, nodes with the timing margin are selected from the data path, and placement and routing of the nodes are changed or standard cells are inserted to perform timing recovery. By selecting the nodes with the timing margin for corresponding recovery, the position to be recovered can be easily and quickly determined, thus ensuring the accuracy of recovery.

In this embodiment, the method further includes: iteration epochs are set, and after the epoch of time closure in S4 is completed, S1-S4 are repeated according to the iteration epochs. By performing multiple epochs of iteration, timing closure can be completed effectively, thus improving the timing closure effect.

It should be noted that by fixing timing violations, the timing path will be optimized, the delay will be reduced, and after one epoch of timing recovery is completed, one epoch of time closure is completed. By means of multiple epochs of valid iterations, the timing path can be better optimized, and the timing closure can be better completed.

In this embodiment, the method further includes: after the physical placement and routing in S4 are completed, timing verification is performed on the script data in the EDA software, and data obtained after timing recovery are written out. By using the EDA software for timing verification, the accuracy of timing recovery can be guaranteed, and an error, when appearing, can be detected in time to remind designers to take measures.

In this embodiment, in a case where an error is detected in timing verification, the position corresponding to the error can be determined according to the script received by the EDA; then, the timing violation fixing in S4 is performed again on the position corresponding to the error, and other positions without an error do not need to be corrected anymore. When a timing error is detected, the position corresponding to the error can be targeted to be recovered, such that the waste of resources and time caused by timing recovery of the whole SOC is avoided.

### Specific Application Example

Two identical ultra-large-scale SOCs are prepared, timing recovery based on module division is performed on a first ultra-large-scale SOC, and full-chip timing recovery is performed on a second first ultra-large-scale SOC.

The first ultra-large-scale SOC is divided into three modules according to functions and connection relations of the modules, wherein a module 1 includes at top only layer and a processor, a module 2 includes the top only layer and an artificial intelligence processor, and a module 3 includes the top only layer, a memory and an interface module.

The size of timing data of a full chipset and the size of timing data of modules are shown in Table 1:

TABLE 1

| | | | | | Time | | Desired |
|---|---|---|---|---|---|---|---|
| | Size of | Magnitude | Magnitude | Number | of | Epochs | storage |
| | timing | of setup | of hold | of logic | each | of | configuration |
| | data | violation | violation | cells | epoch | timing | of server |
| | (T) | (TNS/ns) | (TNS/ns) | (million) | (h) | eco | (T) |
| Module | 0.6 | −439 | −321 | 35.1 | 4.5 | 7 | 1.2 |
| 1 | | | | | | | |
| Module | 0.7 | −621 | −399 | 45.9 | 6 | 7 | 1.2 |
| 2 | | | | | | | |
| Module | 0.9 | −384 | −226 | 59.3 | 5.5 | 5 | 1.2 |
| 3 | | | | | | | |
| Full | 2.2 | −1205 | −809 | 126.2 | 14 | 10 | 2.8 |
| chipset | | | | | | | |

The size of timing data of the full chipset of the ultra-large-scale SOC reaches 2.2 T, the magnitude of the setup violation reaches −1205 TNS/ns, the magnitude of the hold violation reaches −809 TNS/ns, and the storage configuration of a server should be at least 2.8 T. For the module 1, the module 2 and the module 3, the sizes of timing data are 0.6 T, 0.7 T and 0.9 T respectively, the magnitudes of the setup violation are −439 TNS/ns, −621 TNS/ns and −384 TNS/ns sequentially, and the magnitudes of the hold violation are −321 TNS/ns, −399 TNS/ns and −226 TNS/ns respectively, and the storage configuration of a server should be 1.2 T. By means of module division, the requirement of each module for the storage configuration of the server is greatly lowered, and timing recovery can be implemented by means of a common 1.2 T server.

The server reads each corresponding lib file, lef file, netlist and def file in each module, each specific module requiring timing recovery and each prototype module not requiring timing recovery are determined, and if the three module all require timing recovery, the three modules are all specific modules. Each corresponding lib file and lef file in each specific module are read and transmitted to a timing recovery tool, and cells with the hold violation or the setup violation and the positions of the cells are determined, and these cells are to-be-recovered parts.

Then, multiple process corners are created for each specific module.

The PRIME_TIME timing recovery tool acquires timing data corresponding to each process corner; each corresponding netlist and def file are back-annotated and read out of the multiple process corners corresponding to each specific module, and other parts other than the to-be-recovered parts in each module are annotated with “don't touch” and taken as attribute-maintained parts; then, a timing recovery command is sent out for the to-be-recovered parts, and for timing violations happening to the to-be-recovered cells, whether there is a timing margin on the data path is analyzed, suitable nodes with the timing margin are selected, and timing recovery is completed by changing placement and routing or inserting standard cells.

Next, the timing recovery tool writes script data corresponding to timing recovery and transmits the script data into EDA software, and the EDA software reads the script data and performs actual standard cell insertion and physical placement and routing to complete actual timing recovery.

After the physical placement and routing are completed, existing timing data are extracted to be analyzed, and data in the first epoch are shown in Table 2.

TABLE 2

| | | | | | Violation value of | | |
|---|---|---|---|---|---|---|---|
| | Violation value | | | | artificial | | |
| | of interface | | Violation value of | | intelligence | | Time for tool to |
| | module | | processor | | processor | | write script data |
| Type of | (ns) | | (ns) | | (ns) | | (h) |
| violation | setup | hold | setup | hold | setup | hold | \ |
| Initial | −439 | −321 | −621 | −399 | −384 | −226 | 6 |
| Epoch 1 | −283 | −102 | −489 | −147 | −176 | −121 | 6 |
| Epoch 2 | −117 | −24 | −202 | −28 | −83 | −43 | 6 |
| Epoch 3 | −89 | −9 | −133 | −10 | −35 | −11 | 6 |
| Epoch 4 | −26 | −2 | −60 | −5 | −8 | −4 | 6 |
| Epoch 5 | −11 | −1 | −25 | −2 | −1 | −1 | 6 |
| Epoch 6 | −3 | −0.4 | −6 | −1 | \ | \ | 6 |
| Epoch 7 | −1 | −0.2 | −2 | −0.3 | \ | \ | 6 |

After the first epoch of timing recovery is completed, the violation value of the interface module, the violation value of the processor and the violation value of the artificial intelligent processor are all reduced, and it takes only 6h for the timing recovery tool to write the script data.

Then, the second epoch of timing recovery is performed according to the above process until the fifth epoch of timing recovery is ended, and at this moment, all the violation values of the artificial intelligence processor are fixed. In the sixth epoch of timing recovery, the module 2 corresponding to the artificial intelligence processor will be taken as an attribute-maintained part, and timing recovery is performed only on the interface module corresponding to the module 3 and the processor corresponding to the module 1. When the seventh epoch of timing recovery is ended, the violation values of all the modules are almost 0.

Similarly, full-chip timing recovery data of the second ultra-large-scale SOC are shown in Table 3:

TABLE 3

| | Full-chip | | Time for tool to write |
|---|---|---|---|
| | violation value (ns) | | script data (h) |
| Type of violation | setup | hold | \ |
| Initial | −1205 | −809 | 14 |
| Epoch 1 | −962 | −195 | 14 |
| Epoch 2 | −920 | −13 | 14 |
| Epoch 3 | −484 | −19 | 14 |
| Epoch 4 | −474 | −4 | 14 |
| Epoch 5 | −281 | −1 | 14 |
| Epoch 6 | −101 | −0.5 | 14 |
| Epoch 7 | −44 | −0.7 | 14 |
| Epoch 8 | −9 | −2 | 14 |
| Epoch 9 | −1 | 0 | 14 |
| Epoch 10 | 0 | 0 | 14 |

It can be known from Table 3 that the full-chip timing recovery requires a 2.8 T high-performance server, more epochs of timing recovery are needed, it takes 14h for the timing recovery tool to write script data in each epoch, and all data are lower than the data of timing recovery based on module division. Even if in a same epoch (such as the seventh epoch), timing recovery of the modules has almost completed, while there is still a-44.7 ns violation value in full-chip timing recovery, indicating that timing recovery based on module division is more advanced and effective.

According to the invention, a large amount of timing data of the ultra-large-scale SOC is divided into groups by module division, such that the processing pressure in timing recovery is effectively reduced, a high-performance server is not needed, and the cost is effectively reduced; moreover, by back-annotating netlist and def to quicky determine parts requiring timing recovery and parts not requiring timing recovery, the timing recovery speed can be increased; in addition, multiple epochs of iterations can be performed to realize efficient timing closure.

The above embodiments are merely used for explaining the technical concept of the invention and are not intended to limit the protection scope of the invention. Any modifications made based on the technical concept of the invention should also fall within the protection scope of the invention.

What is claimed is:

1. A method for implementing timing closure of an ultra-large-scale System on Chip (SOC) based on module division, using a timing recovery tool and Electronic Design Automation (EDA) software to perform the timing closure of the ultra-large-scale SOC, wherein the method comprises the following steps:
S1, acquiring timing data of a full chipset in the ultra-large-scale SOC, and dividing the ultra-large-scale SOC into three modules;
S2, reading each corresponding lib file, lef file, netlist and def file in each module, and determining each specific module requiring timing recovery and each prototype module not requiring timing recovery;
S3, creating, in the timing recovery tool, a plurality of process corners corresponding to each specific module determined in S2, and acquiring timing data corresponding to each process corner; back-annotating and reading, by the timing recovery tool, each corresponding netlist and def file out of the plurality of process corners corresponding to each specific module to determine an attribute-maintained part and a to-be-recovered part; setting the attribute-maintained part and each prototype module determined in S2 to be in a not-to-be-recovered state; and
S4, sending out, by the timing recovery tool in S3, a timing recovery command to perform timing violation fixing on the to-be-recovered part determined in S3; after the timing violation fixing is completed, sending, by the timing recovery tool, script data corresponding to the timing violation fixing to the EDA software; performing physical placement and routing by the EDA software according to the script data to complete one epoch of timing closure.

2. The method for implementing timing closure of the ultra-large-scale SOC based on module division according to claim 1, wherein the ultra-large-scale SOC comprises a top only layer, a processor, an artificial intelligence processor, a memory and an interface module; and in S1, three modules divided from the ultra-large-scale SOC are a first module, a second module and a third module;
wherein, the first module comprises the top only layer and the processor, the second module comprises the top only layer and the artificial intelligence processor, and the third module comprises the top only layer, the memory and the interface module.

3. The method for implementing timing closure of the ultra-large-scale SOC based on module division according to claim 1, wherein in S2, when each specific module requiring timing recovery is determined, if there are at least two specific modules, the at least two specific modules are processed parallelly.

4. The method for implementing timing closure of the ultra-large-scale SOC based on module division according to claim 1, wherein in S3, the plurality of process corners are created according to a process parameter, a voltage parameter and a temperature parameter corresponding to each specific module.

5. The method for implementing timing closure of the ultra-large-scale SOC based on module division according to claim 1, wherein in S4, a method for performing the timing violation fixing comprises: analyzing a timing margin on a data path of the to-be-recovered part, selecting nodes with the timing margin from the data path, and changing placement and routing of the nodes to perform timing recovery.

6. The method for implementing timing closure of the ultra-large-scale SOC based on module division according to claim 1, further comprising: setting iteration epochs, and after the epoch of timing closure in S4 is completed, repeating S1-S4 according to the iteration epochs.

7. The method for implementing timing closure of the ultra-large-scale SOC based on module division according to claim 1, further comprising: after the physical placement and routing in S4 are completed, performing timing verification on the script data in the EDA software.

8. The method for implementing timing closure of the ultra-large-scale SOC based on module division according to claim 7, wherein when an error is detected in the timing verification, a position corresponding to the error is determined according to the script data, and the timing violation fixing in S4 is performed again on the position corresponding to the error.
